(19) United States
(12) Patent Application Publication
(10) Pub. No.: US 2026/0295749 A1
(43) Pub. Date: Oct. 1, 2026

(54) NOISE CONTROL FOR AN AIR FILTRATION ASSEMBLY

(71) Applicant: Apex Brands, Inc., Apex, NC (US)

(72) Inventors: Ralf ZERWECK, Bönnigheim (DE); Bernd NIEDERMAYER, Gemmrigheim (DE)

(21) Appl. No.: 19/489,416

(22) PCT Filed: Apr. 30, 2024
(86) PCT No.: PCT/US2024/026992

§ 371 Date: Dec. 2, 2025

Related U.S. Application Data
(60) Provisional application No. 63/472,892, filed on Jun. 14, 2023.

(51) Int. Cl. B23Q 11/00; G01H 11/08; G10K 11/178

(52) U.S. Cl. CPC B23Q 11/0032; G01H 11/08; G10K 11/17875; G10K 2210/129; G10K 2210/3224

(57) ABSTRACT

An air filtration assembly for filtering gas or particles generated responsive to operation of a work tool may include an intake which may be repositionable relative to the work tool, a housing which may be operably coupled to the intake and may include a filter, a motor and processing circuitry, an exhaust operably coupled to the housing and an active noise control (ANC) assembly to reduce noise generated by the air filtration assembly, which may include a sensor and a speaker. The processing circuitry may control the operation of the air filtration assembly. Air may enter the air filtration assembly at the intake responsive to operation of the motor, before passing through the filter and exiting out the exhaust.

### TECHNICAL FIELD

Example embodiments generally relate to air filtration assemblies and, in particular, relate to such assemblies having noise reduction measures.

### BACKGROUND

Many tasks or processes that may commonly take place in manufacturing or lab settings may generate unwanted byproducts in various forms. For example, processes involving certain materials and chemicals may create waste that may need to be dealt with appropriately either via proper disposal or cleaning. In some cases, the byproducts may be airborne and may require the use of an air filtration assembly to dispose of them accordingly. One such task that may generate airborne byproducts may be soldering. Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. A tip portion of the soldering tool may, due to operation of a heater, become hot enough to melt solder that contacts the tip portion. The act of melting the solder, and thus soldering in general, may release gas into the air that may contain volatile organic compounds (VOC's) or other chemicals.

Soldering and other related tasks may often be performed at a workstation indoors. In some cases, the workstation may be located proximate to other workstations and sometimes within the same room. Thus, an air filtration assembly may be employed to filter the air proximate to the workstation where the task may be taking place. Common considerations to make regarding the configuration and use of the air filtration assembly may include ensuring it is adequately sized for the space it is occupying, ensuring it is operating effectively, and improving its overall ease of operation/user experience. Thus, it may be desirable to provide an improved air filtration assembly to address some of the above considerations to create an environment that may be safer for the operator and other potential surrounding workstations.

### BRIEF SUMMARY OF SOME EXAMPLES

In an example embodiment, an air filtration assembly for filtering gas or particles generated responsive to operation of a work tool may be provided. The air filtration assembly may include an intake which may be repositionable relative to the work tool, a housing which may be operably coupled to the intake and may include a filter, a motor and processing circuitry, an exhaust operably coupled to the housing and an active noise control (ANC) assembly to reduce noise generated by the air filtration assembly, which may include a sensor and a speaker. The processing circuitry may control the operation of the air filtration assembly. Air may enter the air filtration assembly at the intake responsive to operation of the motor, before passing through the filter and exiting out the exhaust.

In another example embodiment, an active noise control assembly for reducing noise generated by an air filtration assembly for filtering gas or particles generated responsive to operation of a work tool may be provided. The ANC assembly may include a sensor which may be configured to detect noise generated by the air filtration assembly, and a speaker. The ANC assembly may communicate with processing circuitry of the air filtration assembly to control the operation of the ANC assembly.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a work system according to an example embodiment;

FIG. 2 illustrates a perspective view of the air filtration assembly generating noise in accordance with an example embodiment;

FIG. 3 illustrates a block diagram of an active noise control assembly according to an example embodiment;

FIG. 4 illustrates a block diagram of an active noise control assembly according to an example embodiment; and

FIG. 5 illustrates a perspective view of the air filtration assembly with passive noise control components in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of an air filtration assembly that may include features to improve its user experience. In some cases, the air filtration assembly may employ active noise control to reduce the overall noise generated by the air filtration assembly. This may accordingly improve the user experience for any user in the near vicinity of the air filtration assembly by improving their ability to converse and hear other sounds as needed. However, other strategies and features are also contemplated as described in greater detail below.

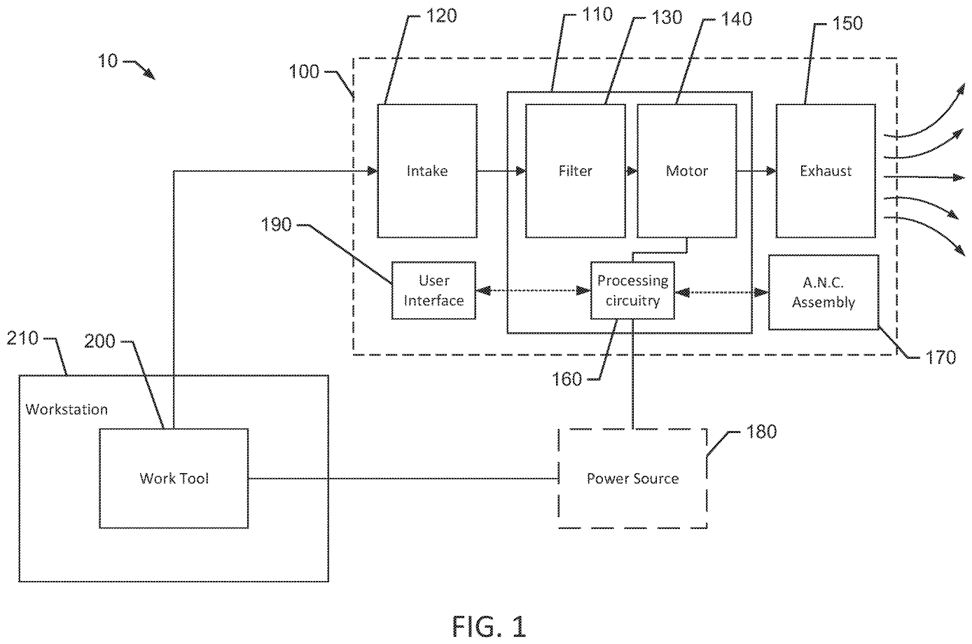

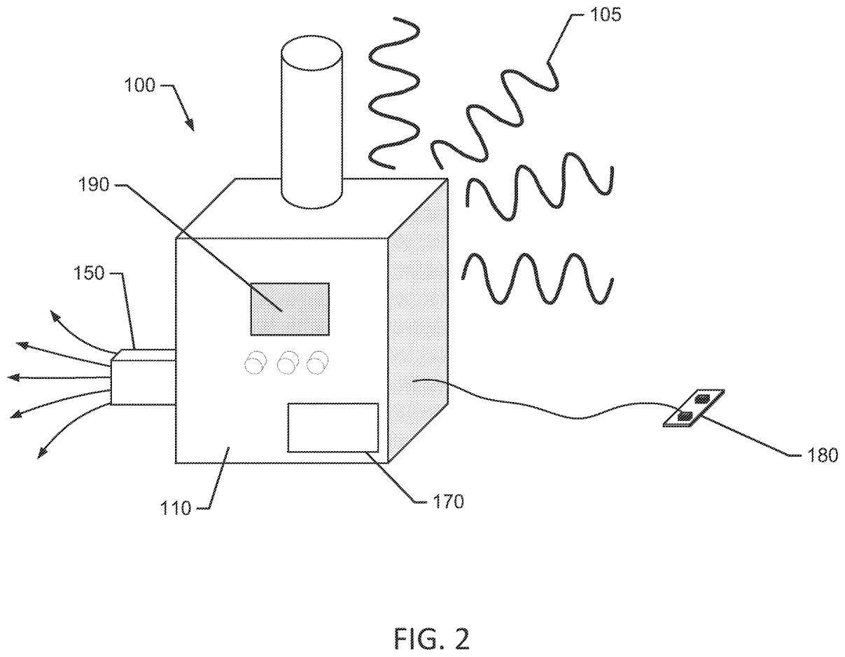

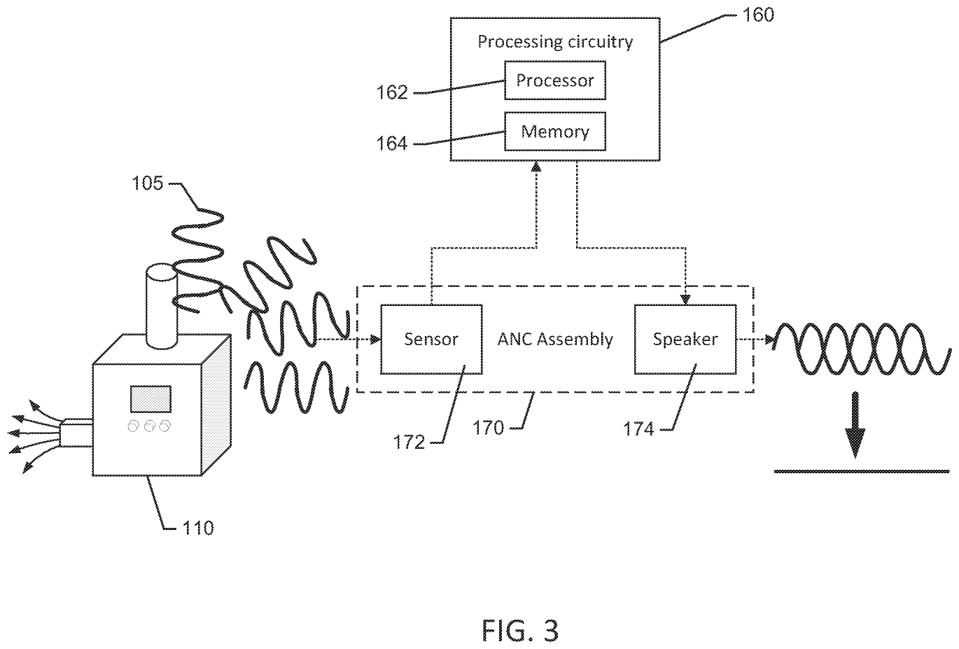

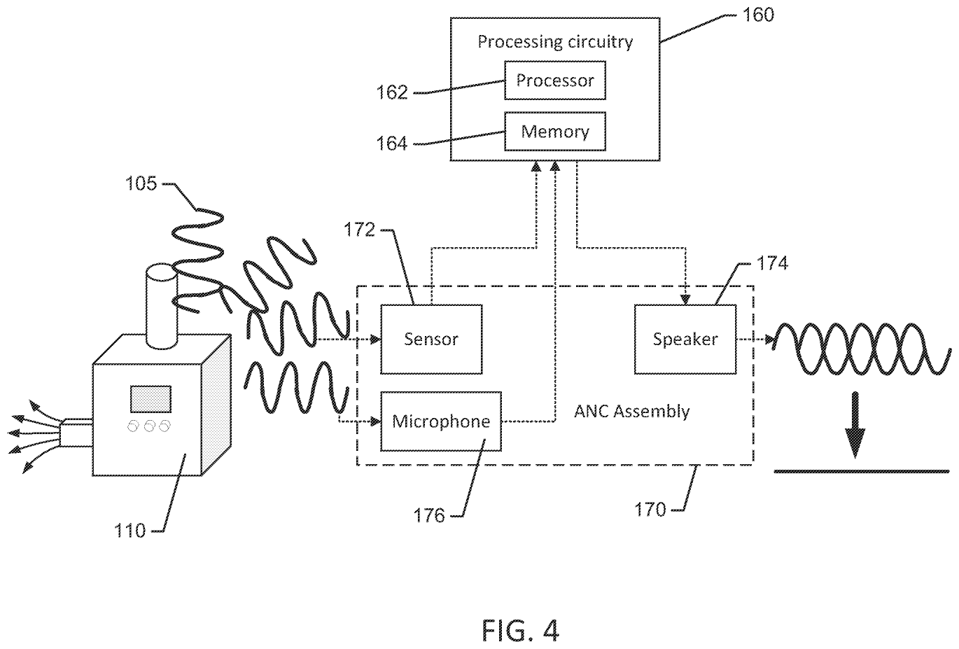

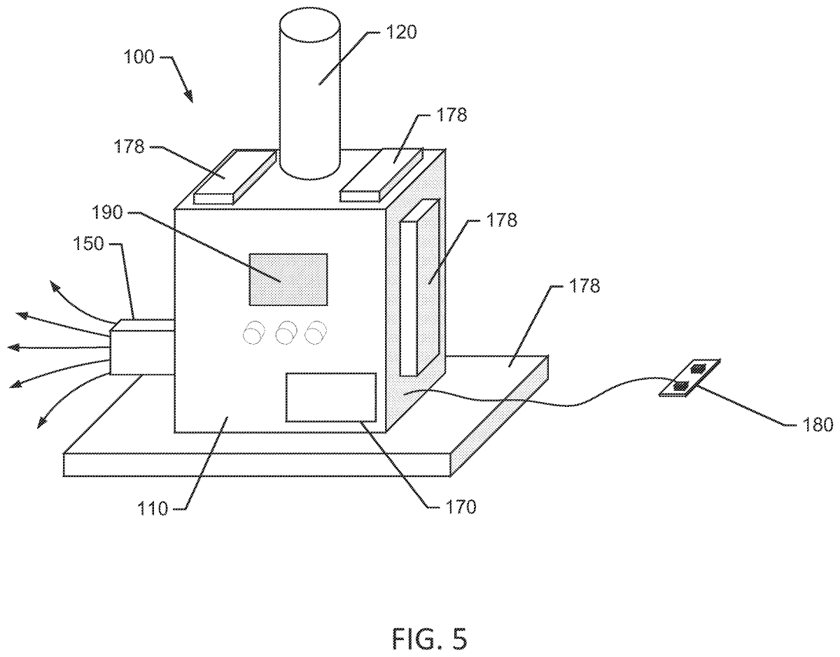

FIG. 1 illustrates a block diagram of a work system 10 according to an example embodiment. FIG. 2 illustrates a perspective view of the air filtration assembly 100 generating noise in accordance with an example embodiment. FIG. 3 illustrates a block diagram of the active noise control assembly 170 according to an example embodiment. FIG. 4 illustrates a block diagram of the active noise control assembly 170 according to an example embodiment. FIG. 5 illustrates a perspective view of the air filtration assembly with passive noise control components in accordance with an example embodiment.

The work system 10 of FIG. 1 may include an air filtration assembly 100, a work tool 200 and a workstation 210. The air filtration assembly 100 may include a housing 110, an intake 120, a filter 130, a motor 140, an exhaust 150 and processing circuitry 160. In some cases, the housing 110 may contain the filter 130, the motor 140 and the processing circuitry 160 within the housing 110. The housing 110 may take on any number of shapes and sizes depending on various design constraints such as the volume of air that the air filtration assembly 100 may need to filter, or in what type of setting the air filtration assembly 100 may be used in. For example, in some cases the air filtration assembly 100 may be a relatively small assembly, and thus the housing 110 may be configured to be disposed on a desktop/workbench. In other cases the air filtration assembly 100 may be slightly larger and thus the housing 110 may be configured to be disposed under a desk/workbench. In still another case, the air filtration assembly 100 may be even larger still and configured to be disposed nearby as a standalone assembly. Thus, the housing 110 may take on different shapes and/or sizes depending on the particular needs and configuration of each embodiment dictated by the environment and the particular use case of the air filtration assembly 100.

The housing 110 may also include the intake 120 and the exhaust 150 operably coupled thereto. In this regard, and as shown in FIG. 1, air may enter the air filtration assembly 100 through the intake 120 before proceeding to pass through the filter 130 responsive to the operation of the motor 140 driving a fan or other mechanism to facilitate airflow through the air filtration assembly 100. The air may exit the air filtration assembly 100 through the exhaust 150 where it may then reenter the immediate surrounding environment, or be directed elsewhere, responsive to having any airborne particles filtered out of the air by the filter 130. In some cases, the filter 130 may be a high efficiency particulate air (HEPA) filter. In some other cases, different levels/forms of filtration may be desired which may necessitate different types of filters for larger or smaller airborne particulates, and even some gaseous compounds.

As the air filtration assembly 100 operates, it may generate noise 105 from a plurality of sources. In some cases, the intake 120 may generate noise 105 due to the air entering the air filtration assembly 100 at the intake 120. In other cases, the exhaust 150 may generate noise 105 due to the air exiting the air filtration assembly 100 at the exhaust 150. In an example embodiment, the housing 110 may also generate noise 105. The housing 110 may generate noise 105 from the operation of any of the various components of the air filtration assembly 100 contained within the housing 110 or from the housing 110 itself, perhaps through vibration of the housing 110. In any case, the noise 105 generated by the air filtration assembly 100 may be nontrivial, and in some cases, substantial. The noise 105 may be made worse by the fact that the air filtration assembly 100 may be operated indoors in a room that may contain many air filtration assemblies 100. Thus, noise control may be a top priority for the user of the air filtration assembly 100 in order to improve the user experience with the air filtration assembly 100. In this regard, the air filtration assembly 100 may include an active noise control (ANC) assembly 170.

The air filtration assembly 100 may be powered by a power source 180 which, according to an example embodiment, may be a source of electrical energy such as a battery or a connection to mains power. Operation of the air filtration assembly 100 may be controlled by the processing circuitry 160 which may be operably coupled to the power source 180 to control the delivery of power to the motor 140 accordingly. In this regard, the processing circuitry 160 may also be operably coupled to a user interface 190 that, in some cases, may be disposed at the housing 110. The user interface 190 may be operable by a user to change certain operating parameters of the air filtration assembly 100, such as powering on/off the air filtration assembly 100 and changing an operating speed of the motor 140, among others. In some cases, the processing circuitry 160 may control the operation of the air filtration assembly 100 automatically responsive to input from the ANC assembly 170 and without user input from the user interface 190. In another example embodiment, the processing circuitry 160 may operate the air filtration assembly 100 at a set operating speed for specific time intervals responsive to user input at the user interface 190 selecting such a mode of operation.

The processing circuitry 160 may be configured to provide electronic control inputs to one or more functional units of the air filtration assembly 100 and to process data received at or generated by the one or more functional units of the air filtration assembly 100. Thus, the processing circuitry 160 may be configured to perform data processing, control function execution and/or other processing and management services according to an example embodiment. In some embodiments, the processing circuitry 160 may be embodied as a chip or chip set. In other words, the processing circuitry 160 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 160 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 160 may include one or more instances of a processor 162 and memory 164 that may be in communication with or otherwise control other components or modules that interface with the processing circuitry 160. As such, the processing circuitry 160 may be embodied as a circuit chip (e.g., an integrated circuit chip) configured (e.g., with hardware, software or a combination of hardware and software) to perform operations described herein. In some embodiments, the processing circuitry 160 may be embodied as a portion of an onboard computer housed in the housing 110 of the air filtration assembly 100 to control operation of the assembly.

In some other cases, the user interface 190 may not be disposed at the housing 110 and may instead be disposed at a personal electronic device of the user. In this regard, the user may be able to configure the operation of the air filtration assembly 100 wirelessly from a personal electronic device such as a smart phone, a tablet, or a personal computer, any of which may act as the user interface 190 in such embodiments. The user interface 190 may be in communication (i.e. either wirelessly or by wire) with the processing circuitry 160 to receive an indication of a user input at the user interface 190 and/or to provide an audible, visual, tactile or other output to the user. As such, the user interface 190 may include, for example, a display, one or more switches, lights, buttons or keys, speaker, and/or other input/output mechanisms. However, more complex interface mechanisms could be provided in some cases. In some cases, the processing circuitry 160 may control the operating speed of the motor 140 based on input provided to the user interface 190 of the air filtration assembly 100.

FIGS. 1 and 2 also depict a work tool 200 and a workstation 210, which the air filtration assembly 100 may be operably coupled to and/or disposed proximate to. In this regard, the workstation 210 may be a table, desk, workbench or any other sort of structure at which a user may perform a work task. In some cases, the workstation 210 may not include a structure at all, and may simply be a general area in which the work tool 200 may be disposed. The work tool 200 may be any number of a variety of tools depending on a task that is desired to be accomplished. For example, the work tool 200 may be a soldering tool, a laser cutting tool, a 3D printer, an injection molding tool, a mill, a lathe, a power saw or many other types of tools commonly used in manufacturing and engineering. For the purposes of illustration and explanation of the components and associated structures of the air filtration assembly 100, the work tool 200 shown in FIG. 2 may be a soldering tool.

The ANC assembly 170 may be disposed at any of a plurality of locations at the air filtration assembly 100, but in an example embodiment the ANC assembly 170 may be disposed at the housing 110. The ANC assembly 170 of an example embodiment may include a sensor 172 and a speaker 174. The sensor 172 may detect the noise 105 generated by the air filtration assembly 100. As mentioned above, the air filtration assembly 100 may generate noise 105 from a variety of sources. In some cases, the noise 105 generated via the vibration of the housing 110 may be the most prevalent noise 105 and/or perhaps the most consistent noise 105. In other words, the housing 110 may emit noise 105 in a consistent fashion responsive to the housing 110 and/or its components vibrating at certain natural resonant frequencies. Thus, the noise 105 may be a consistent noise 105 which may be simpler to control. In this regard, the sensor 172 may be a piezo vibration sensor in some embodiments. The sensor 172 may thus be disposed at the housing 110 to detect the noise 105 generated via vibration. In some cases, the ANC assembly 170 may include a microphone 176 as well. The microphone 176 may be employed alone or in conjunction with the sensor 172 in the ANC assembly 170. In an example embodiment, the sensor 172 may be the piezo vibration sensor and the microphone 176 may be employed to improve the noise detection capability of the ANC assembly 170, but the microphone 176 may not be a necessary component of the ANC assembly 170. In still some other cases, the sensor 172 may be any other form of sound sensor capable of detecting the noise 105 generated by the air filtration assembly 100. Of note, the sensor 172 may also be disposed at either of the intake 120 or the exhaust 150 as well, depending on the preference of the user and the noise 105 generated by each of these components. In some example embodiments, the air filtration assembly 100 may include a plurality of ANC assemblies 170 disposed at various locations at the air filtration assembly 100. For example, the air filtration assembly 100 may include an ANC assembly 170 disposed at each of the intake 120, the housing 110 and the exhaust 150.

As shown in the embodiment depicted in FIGS. 3 and 4, the sensor 172, and in some cases the microphone 176 too, may therefore detect sound waves of the noise 105 generated by the air filtration assembly 100 and may convert the sound waves into an electronic signal corresponding to the sound wave. The signal may thus be the electronic representation of the physical sound wave and may therefore correspond to the natural frequency of the noise 105. The sensor 172 may communicate the signal to the processing circuitry 160, which may include an algorithm in the memory 164 that may analyze the signal from the sensor 172 and shift a phase of the signal by 180°. The processing circuitry 160 may then communicate the phase-shifted signal to the speaker 174 to be emitted out into the environment. The phase-shifted signal emitted by the speaker 174 may interfere with the noise 105 generated by the air filtration assembly 100 in a destructive manner. In this regard, the signal and the phase-shifted signal may each include their respective crests and troughs. If, for example a first sound wave and a second sound wave are in the same phase and the first and second sound waves interfere with each other, that may be called constructive interference. In constructive interference, the first and second sound waves may combine into one sound wave and the amplitude may increase as a result of the crests and troughs of each of the first and second sound waves being in phase (i.e. in the same positions). However, the principle that the ANC assembly 170 may rely on may be called destructive interference. In this regard, for example, if a first sound wave and a second sound wave are in opposite phases (i.e. phase shifted by 180°) and the first and second sound waves interfere with each other, the waves may destructively interfere with each other. In destructive interference, the first and second sound waves may combine into one sound wave and the amplitude may decrease as a result of the crests and troughs of each of the first and second sound waves being out of phase. In other words, the crests of the first sound wave align with the troughs of the second sound wave. The result, in theory, may be complete, or near complete, reduction of noise 105 perceived by the user. Thus, the ANC assembly 170 may rely on destructive interference between the noise 105 generated by the air filtration assembly 100 and the phase-shifted sound signal emitted by the speaker 174 to reduce the effective volume of the air filtration assembly 100.

In an example embodiment, the air filtration assembly 100 may create a feedback loop using the ANC assembly 170. In this regard, the processing circuitry 160 may control the operating speed of the motor 140, and the general operation of the air filtration assembly 100, responsive to the sensor 172 detecting the noise 105 generated by the air filtration assembly 100. The sensor 172 may detect the noise 105 either before or after it has been reduced by the speaker 174. In this regard, if a detected noise level is found to be at or above a preset noise level, then the processing circuitry 160 may slow down the motor 140 to generate less noise 105. In some cases, the above described feedback loop may be an optional setting that may be selectable by a user via the user interface 190 if the user desires to operate the air filtration assembly 100 in a “quiet mode”.

The air filtration assembly 100 of some embodiments may also include passive noise control (PNC) components 178. The PNC components 178 may include insulation members 179 which may be disposed at various parts of the air filtration assembly 100. For instance, in some cases the insulation members 179 may include rubber stripping disposed at the housing 110 to reduce the propagation of vibrations between the intake 120, the filter 130, the motor 140 and the exhaust 150. In another example embodiment, the PNC components 178 may include ear muffs to be worn by the user of the air filtration assembly 100. In some cases, the PNC components 178 may include a rubber mat which the housing 110 of the air filtration assembly 100 may be disposed on. In still some other cases, the PNC components 178 may include foam insulation disposed at a plurality of locations at the air filtration assembly 100.

In some cases, the air filtration assembly 100 may be one assembly amongst others in a larger air filtration system 220. In such cases, the air filtration system 220 may include a plurality of air filtration assemblies 100 perhaps disposed at a plurality of workstations 210. In such cases, the air filtration system 220 may include a main assembly 230 and a plurality of subassemblies 240. The main assembly 230 and the subassemblies 240 may each be an air filtration assembly 100, but the main assembly 230 may be the only air filtration assembly 100 in the air filtration system 220 to include the processing circuitry 160. In this regard, each of the subassemblies 240 may be configured to communicate with the processing circuitry 160 at the main assembly 230 either wirelessly or by wire. In such cases, the ANC assembly 170 may be disposed at the main assembly 230 or the subassembly 240 or both/all of the air filtration assemblies 100 that may be included in the system 220. In this regard, the ANC assembly 170 disposed at the subassembly 240 may communicate with the processing circuitry 160 at the main assembly 230 either wirelessly (e.g. via Bluetooth) or by wire (e.g. via Ethernet cable) to send and receive the signal and phase-shifted signal, respectively. Therefore, both the main assembly 230 and each of the subassemblies 240 may include their own respective ANC assemblies 170 to reduce the noise 105 that they may generate.

Some example embodiments may provide for an air filtration assembly for filtering gas or particles generated responsive to operation of a work tool. The air filtration assembly may include an intake which may be repositionable relative to the work tool, a housing which may be operably coupled to the intake and may include a filter, a motor and processing circuitry, an exhaust operably coupled to the housing and an active noise control (ANC) assembly to reduce noise generated by the air filtration assembly, which may include a sensor and a speaker. The processing circuitry may control the operation of the air filtration assembly. Air may enter the air filtration assembly at the intake responsive to operation of the motor, before passing through the filter and exiting out the exhaust.

In some cases, the air filtration assembly described above may be augmented or modified by altering individual features mentioned above or adding optional features. The augmentations or modifications may be performed in any combination and in any order. For example, in some cases, the sensor may detect the noise generated by the air filtration assembly and may communicate a signal corresponding to the noise to the processing circuitry. In an example embodiment, the processing circuitry may shift a phase of the signal by 180° and may communicate a phase-shifted signal to the speaker. In some cases, the phase-shifted signal may be emitted by the speaker to destructively interfere with the noise generated by the air filtration assembly. In an example embodiment, the sensor may be a piezo vibration sensor. In some cases, the sensor may be disposed at the housing of the air filtration assembly. In an example embodiment, the housing may vibrate as the air filtration assembly operates. In some cases, the piezo vibration sensor may detect the noise generated by the air filtration assembly from the vibration of the housing. In an example embodiment, the air filtration assembly may further include passive noise control components. In some cases, the passive noise control components may include insulation members disposed at the housing. In an example embodiment, the processing circuitry may control an operating speed of the motor based on a detected noise level of the air filtration assembly.

Some example embodiments may provide for an active noise control (ANC) assembly for an air filtration assembly for filtering gas or particles generated responsive to operation of a work tool. The ANC assembly may include a sensor which may be configured to detect noise generated by the air filtration assembly, and a speaker. The ANC assembly may communicate with processing circuitry of the air filtration assembly to control the operation of the ANC assembly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An air filtration assembly for filtering gas or particles generated responsive to operation of a work tool, the air filtration assembly comprising:
an intake repositionable relative to the work tool;
a housing operably coupled to the intake, the housing comprising a filter, a motor and processing circuitry;
an exhaust operably coupled to the housing; and
an active noise control (ANC) assembly to reduce noise generated by the air filtration assembly, the ANC assembly comprising a sensor and a speaker,
wherein air enters the air filtration assembly at the intake responsive to operation of the motor, before passing through the filter and exiting out the exhaust, and
wherein the processing circuitry is configured to control operation of the air filtration assembly.

2. The air filtration assembly of claim 1, wherein the sensor detects the noise generated by the air filtration assembly and communicates a signal corresponding to the noise to the processing circuitry.

3. The air filtration assembly of claim 2, wherein the processing circuitry shifts a phase of the signal by 180° and communicates a phase-shifted signal to the speaker.

4. The air filtration assembly of claim 3, wherein the phase-shifted signal is emitted by the speaker to destructively interfere with the noise generated by the air filtration assembly.

5. The air filtration assembly of claim 1, wherein the sensor is a piezo vibration sensor.

6. The air filtration assembly of claim 5, wherein the sensor is disposed at the housing of the air filtration assembly.

7. The air filtration assembly of claim 6, wherein the housing vibrates as the air filtration assembly operates, and
wherein the piezo vibration sensor detects the noise generated by the air filtration assembly from the vibration of the housing.

8. The air filtration assembly of claim 1, wherein the air filtration assembly further comprises passive noise control components.

9. The air filtration assembly of claim 8, wherein the passive noise control components comprise insulation members disposed at the housing.

10. The air filtration assembly of claim 1, wherein the processing circuitry controls an operating speed of the motor based on a detected noise level of the air filtration assembly.

11. The air filtration assembly of claim 1, wherein the sensor comprises a piezo vibration sensor and a microphone.

12. An active noise control (ANC) assembly for reducing noise generated by an air filtration assembly for filtering gas or particles generated responsive to operation of a work tool, the ANC assembly comprising:
a sensor configured to detect the noise generated by the air filtration assembly; and
a speaker,
wherein the ANC assembly communicates with processing circuitry of the air filtration assembly to control the operation of the ANC assembly.

13. The ANC assembly of claim 12, wherein the sensor communicates a signal corresponding to the noise to the processing circuitry.

14. The ANC assembly of claim 13, wherein the processing circuitry shifts a phase of the signal by 180° and communicates a phase-shifted signal to the speaker.

15. The ANC assembly of claim 14, wherein the phase-shifted signal is emitted by the speaker to destructively interfere with the noise generated by the air filtration assembly.

16. The ANC assembly of claim 12, wherein the sensor is a piezo vibration sensor.

17. The ANC assembly of claim 16, wherein the sensor is disposed at a housing of the air filtration assembly.

18. The ANC assembly of claim 17, wherein the housing vibrates as the air filtration assembly operates, and
wherein the piezo vibration sensor detects the noise generated by the air filtration assembly from the vibration of the housing.

19. The ANC assembly of claim 12, wherein the air filtration assembly further comprises passive noise control components.

20. The ANC assembly of claim 19, wherein the passive noise control components comprise insulation members disposed at a housing of the air filtration assembly.

21. The ANC assembly of claim 12, wherein the processing circuitry controls an operating speed of the air filtration assembly based on a detected noise level of the air filtration assembly.

22. The ANC assembly of claim 12, wherein the sensor comprises a piezo vibration sensor and a microphone.
